(19) United States
(12) Patent Application Publication
(10) Pub. No.: US 2009/0320128 A1
(43) Pub. Date: Dec. 24, 2009

(54) SYSTEM MANAGEMENT INTERRUPT (SMI) SECURITY

(75) Inventors: Alok Pant, Cedar Park, TX (US); James Walker, Cedar Park, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/132,763

(22) Filed: Jun. 4, 2008

(51) Int. Cl. G06F 21/00; G06F 11/00

(52) U.S. Cl. 726/22

(57) ABSTRACT

A system management interrupt (SMI) security system includes one or more subsystems to define a first variable using advanced configuration and power interface (ACPI) source language (ASL) code, define a second variable using system management mode (SMM) code, generate a first soft SMI to generate a random value, update the first and second variables with the generated value, generate a second SMI to perform an operation, compare the values of the first and second variables and perform the operation in response to the first and second variables having a value substantially the same as one another.

### BACKGROUND

The present disclosure relates generally to information handling systems (IHSs), and more particularly to system management interrupt (SMI) security in an IHS.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

In traditional IHS architecture, the basic input/output system (BIOS) SMI handler has no mechanism to differentiate a soft SMI coming from its own advanced configuration and power interface (ACPI) source language (ASL) code or from an external non-trusted source. To increase IHS security, it would be beneficial for the BIOS system management mode (SMM) code to only service requests from its own ASL code and soft system management interrupts (SMIs) from non-trusted sources may be ignored.

In an IHS, part of BIOS code (e.g., ACPI ASL code) runs under the operating system (OS) environment. The ACPI ASL pieces of the BIOS allow the OS to perform BIOS specific tasks and are executed by the OS. The ASL code resides in regular memory and it is very transparent. Anyone can view the ASL source code. For example, users may transfer the ACPI table from a disk operating system (DOS) and emulate the same operation. The security specific BIOS operation is performed under SMM where the OS application/driver does not have access, control, or viewing of the operation. The ASL code can generate a soft SMI for an SMI handler to perform secure or other platform specific operations. Under a more Secure OSs, such as Microsoft Vista™, only an OS ACPI driver can execute the ASL code. In some BIOS systems, the ASL code generates SMM and the SMM handler services all of the soft SMIs regardless if those SMI are coming from BIOS ASL or any virus/OS application. In other words, the Microsoft Vista™ OS does not allow applications to execute an ASL method that does not belong to the OS, nor does the OS allow applications to view the ASL variable current value. However, any other application can still emulate the same ASL operation. As such, a problem arises because a software virus can emulate the same operation by writing the same soft SMI value into an SMI port that the BIOS ASL code will write. It is therefore important to ensure non-trusted applications cannot emulate ASL operation and utilize BIOS operations.

Accordingly, it would be desirable to provide an improved SMI security system absent the disadvantages discussed above.

### SUMMARY

According to one embodiment, a system management interrupt (SMI) security system includes one or more subsystems to define a first variable using advanced configuration and power interface (ACPI) source language (ASL) code, define a second variable using system management mode (SMM) code, generate a first soft SMI to generate a random value, update the first and second variables with the generated value, generate a second SMI to perform an operation, compare the values of the first and second variables and perform the operation in response to the first and second variables having a value substantially the same as one another.

### BRIEF DESCRIPTION OF THE DRAWINGS

FIG. 1 illustrates an embodiment of an information handling system (IHS).

FIG. 2 illustrates a block diagram of an embodiment of an IHS software system.

FIGS. 3A and 3B illustrate a flow chart of an embodiment of a method for a system management interrupt (SMI) security.

FIG. 4 illustrates an embodiment of a sample ASL software code using the ASLValue as a random key to provide a credential to an SMM Handler.

FIG. 5 illustrates an embodiment of a sample SMM software code that is generating a random key and validating the caller key (ASL) before handling the SMM.

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

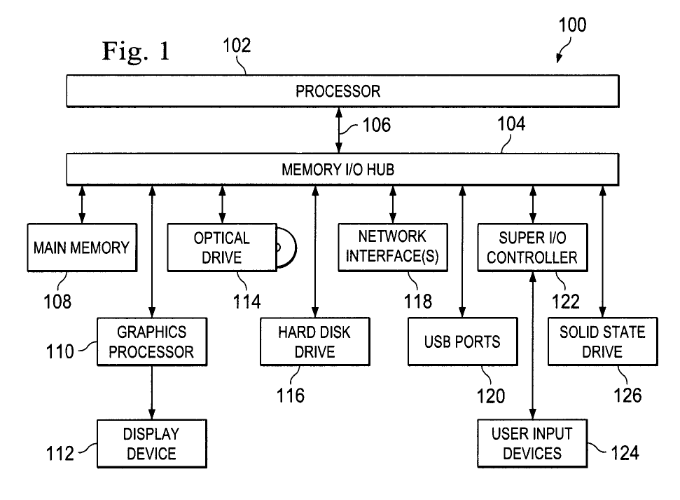

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

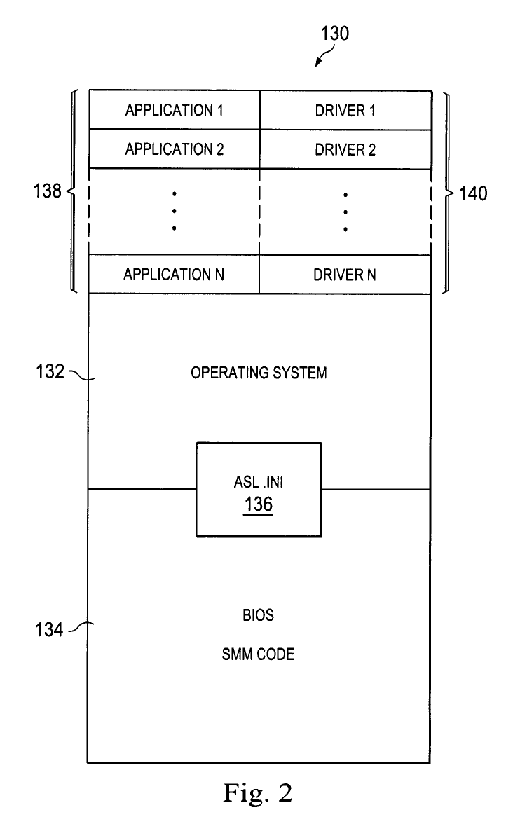

FIG. 2 illustrates a block diagram of an embodiment of an IHS software system 130. As should be readily understood by a person having ordinary skill in the art, the software system 130 has an operating system (OS) 132 in communication with a basic input/output system (BIOS) 134 using an advanced configuration and power interface (ACPI) source language (ASL) 136. In an embodiment, the BIOS 134 includes a system management mode (SMM) for assisting in handling IHS 100 operations. In an embodiment, the ASL 136 includes software code for performing operations. In an embodiment, the ASL 136 includes what are known in the art as “.ini” configuration files as well as other types of files. Also, the software system 130 may include one or more software applications 138 and/or one or more drivers 140 for performing operations using the IHS 100.

In an embodiment, the BIOS 134 will define a variable in the ASL code 136. For simplicity, the variable will be called “ASLValue”. An ASL method may use the variable “ASLValue” when generating a soft SMI as described in more detail below. After generating the The soft SMI, the BIOS ASL code will update “ASLValue” based on the new value from the SMM code in the BIOS 134. In the BIOS read only memory (ROM) image, a SMM variable will be defined. For simplicity, this variable will be called “SMMValue”. In an embodiment, both “ASLValue” and “SMMValue” will be initialized to zero.

When the user of the IHS 100 presses a power button on the IHS 100 to turn on the IHS 100, the BIOS 134 will perform a power on self test (POST) and will load an advanced configuration and power interface (ACPI) Table into memory 108. At the end of the POST, the BIOS 134 hands off control of the IHS 100 to the OS 132. Early on in the OS boot process (e.g., before the OS 132 allows any application 138 to load), the OS 132 calls a BIOS ASL code. As an example, the ASL code may be called “SB._INI( )” method.

In an embodiment, the “SB._INI( )” ASL method will generate a special soft SMI (e.g., a software driven SMI) to the SMM code. In response to this soft SMI code, the SMM handler will generate a random value and update its SMM Variable “SMMValue” with this value. The SMM Handler will return this value to the ASL code. The ASL code may then save this value in the “ASLValue” variable. After the update, the variable “ASLValue” holds a random non-zero value. Later, the OS 132 finishes the IHS 100 boot-up process allowing the IHS 100 to run various applications 138, drivers 140 and also the ASL code 136.

During an OS runtime operation, the ASL code 136 may generate the soft SMI. The ASL code 136 may then supply the “ASLValue”, along with other parameters, to the SMM environment. In an embodiment, the ASL code 136 may encrypt parameters using an “ASLValue” key. Other security methods may be used with the present disclosure. Before serving the Soft SMI request, the SMM handler will compare the value of “ASLValue” with “SMMValue”. If the values of the variables are the same or substantially the same, then the SMM code will service the soft SMI and update the value in the “SMMValue” based on using a standard algorithm. If the value of “ASLValue” is not the same or substantially the same as “SMMValue” then the SMI is not requested by the ASL code and an improper request (e.g., a soft virus) may be attempting to emulate the ASL soft SMI. Therefore, to protect the IHS 100, the SMM Handler will not service that SMI.

In a secure OS 132, the software virus code may be able to dump the ASL method, but it will not be able to receive the current value of “ASLValue” in the soft SMI method. As such, the virus will not be able to retrieve the current value of the “ASLValue” variable and should not be able to fake the value of “ASLValue” stored within the soft SMI ASL method. After serving a request for the SMI, the SMM handler will return a new “ASLValue” to the ASL code which the ASL code will use the next time. Thus, the ASL variable (e.g., ASLValue) is changing during the same OS boot.

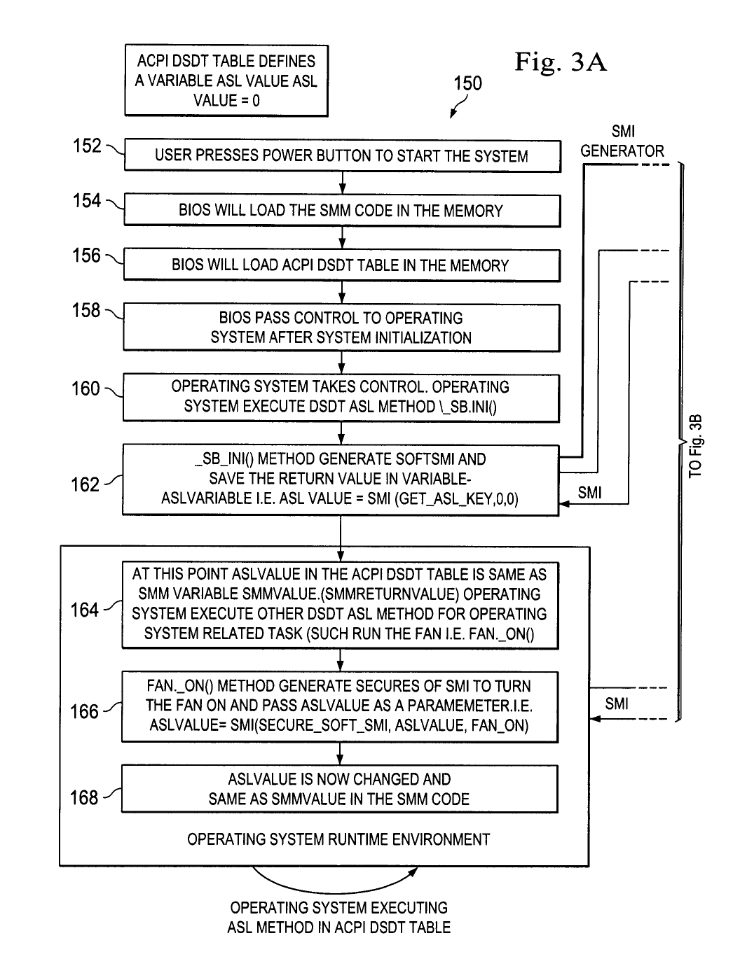

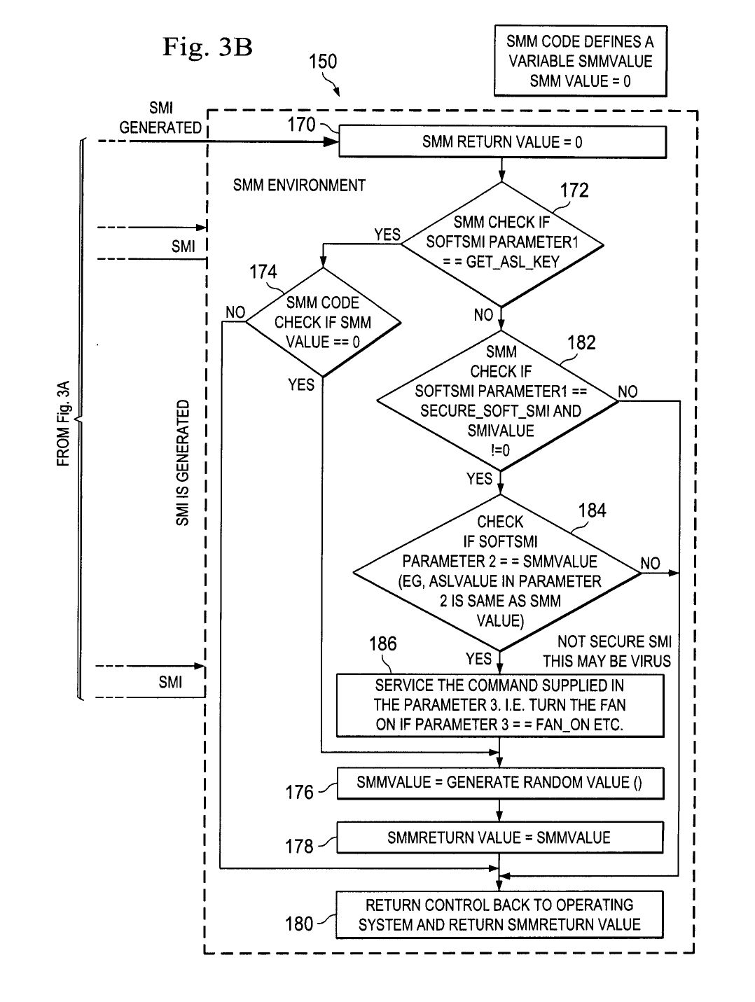

FIGS. 3A and 3B illustrate a flow chart of an embodiment of a method 150 for a system management interrupt (SMI) security. As discussed above, an embodiment of this disclosure defines the variables “ASLValue” and “SMMValue”. For simplicity, the initial values of “ASLValue” and “SMMValue” will be set to zero. However, any initial value may be used for the variables and any number and/or name of variables may be used with this method 150. The method 150 begins at block 152 where a user of the IHS 100 starts operation of the IHS 100, such as by pressing a power button. The method 150 then proceeds to block 154 where the BIOS 134 loads SMM code into memory 108 of the IHS 100. The method 150 proceeds to block 156 where the BIOS 134 loads an ACPI differentiated system description table (DSDT) into memory 108. An ACPI DSDT is generally known as a pre-defined table of information that supplies configuration information about the IHS 100. The method 150 proceeds next to block 158 where the BIOS 134 passes control operations to the OS 132 after the IHS 100 has been initialized.

The method 150 proceeds to block 160 where the OS 132 takes operation control of the IHS 100. During performance of the method 150, the OS 132 may execute a DSDT ASL method for system management security. For example, the DSDT ASL method may be called \_SB.INI( ). However, any name may be used for this method. The method 150 then proceeds to block 162 where the method \_SB.INI( ) generates a soft SMI that is communicated to an SMM environment in the BIOS 134. The SMM environment will return a value for the variable “ASLValue” as will be described in more detail below. At block 162, the method 150 will also save the returned value of the variable “ASLValue” in the memory 108. In an embodiment, the variable “ASLValue”=SMI (GET_ASL_KEY,0,0).

Next, the method 150 shifts to an OS runtime environment in the OS 132 and proceeds to block 164 where the variable “ASLValue” in the ACPI DSDT is the same or substantially the same as the variable “SMMValue”. In block 164, the OS 132 may execute DSDT ASL methods for OS related tasks, such as, running a fan to for cooling components of the IHS 100. This may be demonstrated by a software code operation called FAN._ON( ). The method 150 proceeds to block 166 where the FAN._ON( ) method generates a secure soft SMI to turn on the fan and to pass the value of “ASLValue” as a parameter to the SMM environment in the BIOS 134. This value may be compared with the SMMValue in the SMM environment to determine whether to perform the operation or not. In an embodiment, “ASLValue”=SMI(SECURE_SOFT_SMI, ASLValue, FAN_ON). A soft SMI is generally known as a system management interrupt (SMI) generated by software and not a hardware system or device. It is also noted that during an SMI is generally the only time when the BIOS 134 system is running while the OS 132 is in control of the IHS 100. The method 150 next proceeds to block 168 where the method 150 changes the value of the variable “ASLValue” to match or substantially match the value of “SMMValue” in the SMM code. It is to be understood that, in an embodiment, the OS runtime environment 132 is executing an ASL method using an ACPI DSDT. It is also to be understood that the variables/shared key is updated after servicing the secure SMI.

The method 150 also operates in an SMM environment in the BIOS 134. The method 150 proceeds to block 170 where the method 150 communicates between blocks 162 and 170 when an SMI is generated and a return value (e.g., “SMMReturnValue”) is communicated from the SMM environment to block 162. The method 150 proceeds to decision block 172 where, in an embodiment, the method 150 uses a SMM check to determines whether a soft SMI “Parameter1” equals “GET_ASL_KEY”. If the answer is yes in decision block 172, the method 150 proceeds to decision block 174 where the method 150 uses SMM code to determine whether “SMMValue” has a value of zero. If the answer is yes in decision block 174, the method 150 proceeds to block 176 where the method 150 generates a random value for the variable “SMMValue”. The method 150 then proceeds to block 178 where the method 150 sets the value of the variable “SMMReturnValue” to equal the value “SMMValue”. Next, the method 150 proceeds to block 180 where the method 150 returns IHS 100 control back to the OS 132 and returns the value of “SMMReturnValue” for updating “ASLValue”. If the answer is no in decision block 174, the method 150 proceeds to block 180 for returning control back to the OS 132 without generating a new value for “SMMValue”.

Returning now to decision block 172, if the answer in decision block 172 is no, the method 150 proceeds to decision block 182 where the method 150 uses an SMM check to determine whether the soft SMI “Parameter1” equals “SECURE_SOFT_SMI” and whether “SMMValue” is not equal to zero. If the answer in decision block 182 is no, the method 150 proceeds to block 180. If the answer in decision block 182 is yes, the method 150 proceeds to decision block 184 where the method 150 determines whether the soft SMI “Parameter2” equals “SMMValue”. If the value of the “Parameter2” equals or substantially equals the value of “SMMValue” the method 150 determines that the SMI is a legitimate interrupt and not the result of a software virus or other malicious act. The method 150 then proceeds to block 186 where the method 150 services the command supplied and performs the desired operation, such as turning on the fan. The method 150 then proceeds to block 176 and continues from block 176 as described above.

In an embodiment, the method 150 may determine that the SMM is coming from a fake source such as a software virus, and perform some operation. In this situation, the method 150 may perform an operation of alerting the IHS 100 systems and/or a user of the IHS 100 to improper operation requests. As such, the user of the IHS 100 or the IHS 100 may automatically correct the problem by removing the improper request and thus saving hardware and/or software problems in the future.

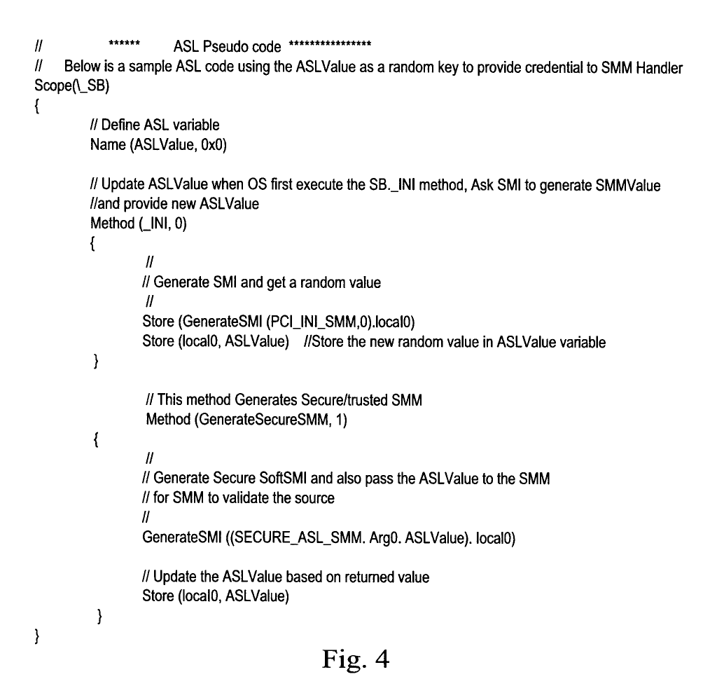

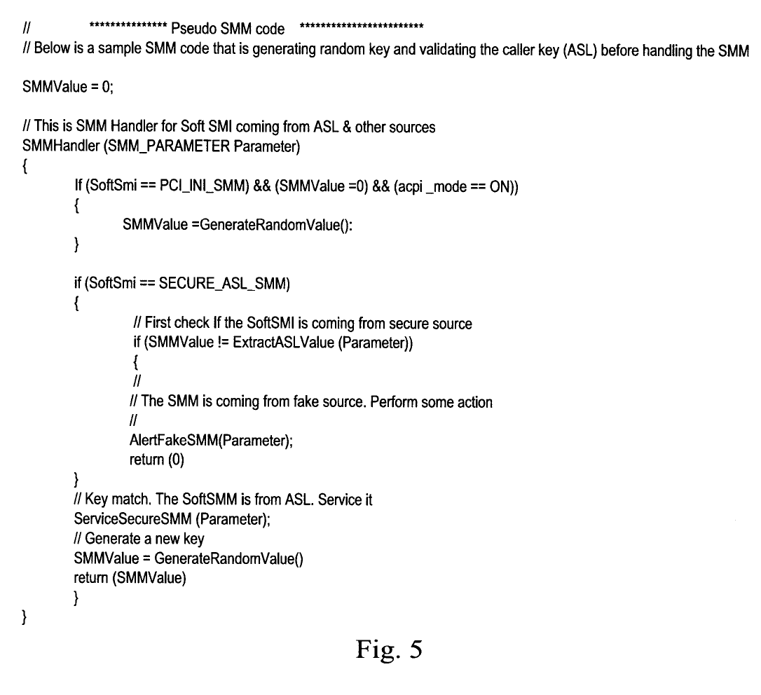

FIG. 4 illustrates an embodiment of a sample ASL software code using the ASLValue as a random key to provide a credential to an SMM Handler. FIG. 5 illustrates an embodiment of a sample SMM software code that is generating a random key and validating the caller key (ASL) before handling the SMM. It should be understood by a person having ordinary skill in the art that other code languages and other code algorithms may be used with the present disclosure.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A system management interrupt (SMI) security system comprising one or more subsystems to:
define a first variable using advanced configuration and power interface (ACPI) source language (ASL) code;
define a second variable using system management mode (SMM) code;
generate a first soft SMI to generate a random value;
update the first and second variables with the generated value;
generate a second SMI to perform an operation;
compare the values of the first and second variables; and
perform the operation in response to the first and second variables having a value substantially the same as one another.

2. The SMI security system of claim 1, wherein the first SMI is a soft SMI.

3. The SMI security system of claim 1, wherein defining the first and second variables is performed using a basic input/output system (BIOS) environment.

4. The SMI security system of claim 1, wherein the second SMI is generated using an operating system environment.

5. The SMI security system of claim 1, wherein a non-authorized operation will cause the first variable to have a different value than the second variable.

6. The SMI security system of claim 1, wherein values of the first and second variables change after the operation has been performed.

7. The SMI security system of claim 1, wherein communication between the ASL code and the SMM code is encrypted.

8. An information handling system comprising:
a processor;
memory coupled with the processor; and
a system management interrupt (SMI) security system comprising one or more subsystems to:
define a first variable using advanced configuration and power interface (ACPI) source language (ASL) code;
define a second variable using system management mode (SMM) code;
generate a first soft SMI to generate a random value;
update the first and second variables with the generated value;
generate a second SMI to perform an operation;
compare the values of the first and second variables; and
perform the operation in response to the first and second variables having a value substantially the same as one another.

9. The IHS of claim 8, wherein the first SMI is a soft SMI.

10. The IHS of claim 8, wherein defining the first and second variables is performed using a basic input/output system (BIOS) environment.

11. The IHS of claim 8, wherein the second SMI is generated using an operating system environment.

12. The IHS of claim 8, wherein a non-authorized operation will cause the first variable to have a different value than the second variable.

13. The IHS of claim 8, wherein values of the first and second variables change after the operation has been performed.

14. The IHS of claim 8, wherein communication between the ASL code and the SMM code is encrypted.

15. A method of performing a system management interrupt (SMI) on an information handling system comprising:
defining a first variable using advanced configuration and power interface (ACPI) source language (ASL) code;
defining a second variable using system management mode (SMM) code;
generating a first soft SMI to generate a random value;
updating the first and second variables with the generated value;
generating a second SMI to perform an operation;
comparing the values of the first and second variables; and
performing the operation in response to the first and second variables having a value substantially the same as one another.

16. The method of claim 15, wherein the first SMI is a soft SMI.

17. The method of claim 15, wherein defining the first and second variables is performed using a basic input/output system (BIOS) environment.

18. The method of claim 15, wherein the second SMI is generated using an operating system environment.

19. The method of claim 15, wherein a non-authorized operation will cause the first variable to have a different value than the second variable.

20. The method of claim 15, wherein values of the first and second variables change after the operation has been performed.
